(19) United States
(12) Patent Application Publication
(10) Pub. No.: US 2015/0312391 A1
(43) Pub. Date: Oct. 29, 2015

(54) AUTOMATIC CALL CONTROL METHOD FOR SELECTION OF CALL APPROACHES

(71) Applicant: MediaTek Inc., Hsin-Chu (TW)

(72) Inventors: Shu-Huei YANG, Banqiao City (TW); Tang-Te LO, Taipei City (TW); Peng-An CHEN, Taipei City (TW); Yu-Ren KE, Taichung City (TW)

(73) Assignee: MediaTek Inc., Hsin-Chu (TW)

(21) Appl. No.: 14/262,974

(22) Filed: Apr. 28, 2014

(51) Int. Cl. H04M 1/2745; H04M 3/42

(52) U.S. Cl. CPC H04M 1/274575; H04M 3/42195; H04M 3/42059

(57) ABSTRACT

An automatic call control method includes the steps of: receiving a mobile terminated call; checking whether the mobile terminated call matches a call rule; and if the mobile terminated call matches the call rule, rejecting the mobile terminated call, and then performing a callback according to a predetermined call approach corresponding to the call rule.

### BACKGROUND OF THE INVENTION

1. Field of the Invention

The disclosure generally relates to an automatic call control method, and more particularly, to an automatic call control method for selection of call approaches.

2. Description of the Related Art

Nowadays, preferential call services, such as unlimited call services, are available from many telecommunication suppliers. However, these preferential call services are often restricted to a specific condition, and it is not convenient for a user to always check whether the specific condition is satisfied before the user answers incoming calls. For example, when receiving a phone call from a caller, the user may first determine whether the phone call is directed to the right SIM (Subscriber Identity Module) card with a preferential call service; otherwise, the caller may accrue expensive phone bills. Accordingly, there is a need to design a new call control method to solve the above problem.

### BRIEF SUMMARY OF THE INVENTION

In one exemplary embodiment, the disclosure is directed to an automatic call control method for use in an electronic device, including the steps of: receiving a mobile terminated call; checking whether the mobile terminated call matches a call rule; and if the mobile terminated call matches the call rule, rejecting the mobile terminated call, and then performing a callback according to a predetermined call approach corresponding to the call rule.

In another exemplary embodiment, the disclosure is directed to an electronic device, including: a storage device, storing at least one call rule and at least one corresponding predetermined call approach; a transceiver, receiving a mobile terminated call; and a processor, checking whether the mobile terminated call matches the call rule, wherein if the mobile terminated call matches the call rule, the processor further call rejects the mobile terminated call and then performs a callback according to the predetermined call approach.

In one exemplary embodiment, the disclosure is directed to a non-transitory computer-readable medium storing a computer program product operable to cause an electronic device to perform operations including: receiving a mobile terminated call; checking whether the mobile terminated call matches a call rule; and if the mobile terminated call matches the call rule, rejecting the mobile terminated call, and then performing a callback according to a predetermined call approach corresponding to the call rule.

### BRIEF DESCRIPTION OF DRAWINGS

The invention can be more fully understood by reading the subsequent detailed description and examples with references made to the accompanying drawings, wherein:

FIG. 1 is a diagram for illustrating an electronic device according to an embodiment of the invention;

FIG. 2 is a flowchart for illustrating an automatic call control method related to an electronic device according to an embodiment of the invention;

FIG. 3 is a flowchart for illustrating some optional steps of an automatic call control method related to an electronic device according to an embodiment of the invention;

FIG. 4 is a flowchart for illustrating some optional steps of an automatic call control method related to an electronic device according to an embodiment of the invention; and

FIG. 5 is a flowchart for illustrating some optional steps of an automatic call control method related to an electronic device according to an embodiment of the invention.

### DETAILED DESCRIPTION OF THE INVENTION

In order to illustrate the purposes, features and advantages of the invention, the embodiments and figures of the invention will be described in detail as follows.

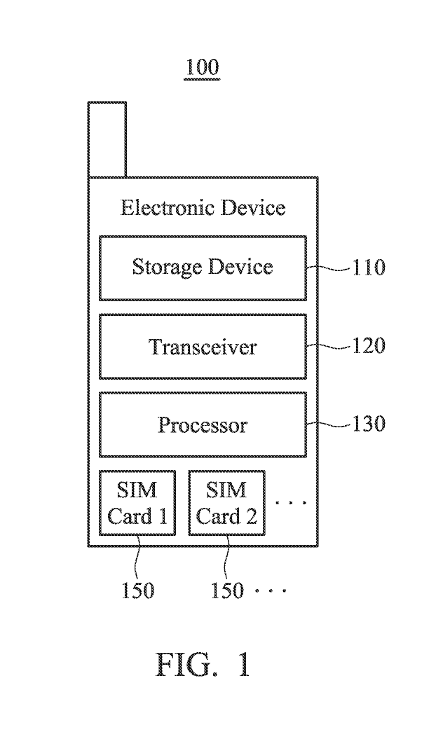

FIG. 1 is a diagram for illustrating an electronic device 100 according to an embodiment of the invention. The electronic device 100 may be a smartphone, a tablet computer, a notebook computer, or any electronic device with a wireless communication function. A user may use the electronic device 100 to communicate with another user (e.g., a caller). In the embodiment of FIG. 1, the electronic device 100 includes a storage device 110, a transceiver 120, a processor 130, and one or more SIM (Subscriber Identity Module) cards 150. The operations of the above components will be described in the following embodiments. It is understood that the storage device 110, the transceiver 120, and the processor 130 of the electronic device 100 may be implemented with hardware, such as physical integrated circuits, or with software, such as computer program products stored in a non-transitory computer-readable medium. In some embodiments, the electronic device 100 further includes other components, such as a touch control panel, a processor, a speaker, a battery, and a housing.

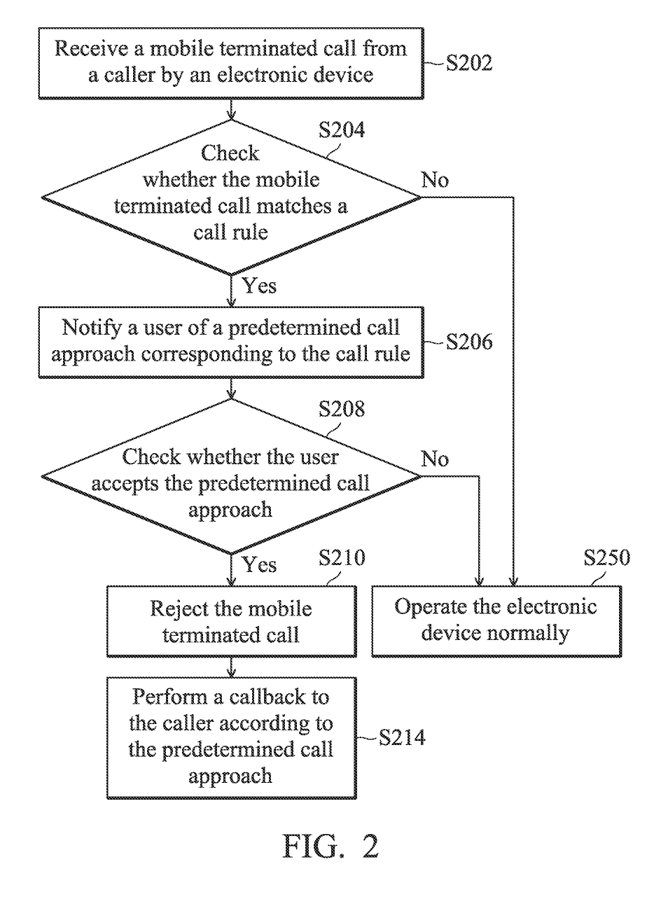

FIG. 2 is a flowchart for illustrating an automatic call control method related to the electronic device 100 according to an embodiment of the invention. Please refer to FIG. 1 and FIG. 2 together. The storage device 110 is configured to store at least one call rule and at least one corresponding predetermined call approach. In step S202, the transceiver 120 receives a mobile terminated call (MT call) from a caller. The mobile terminated call may be a CS (Circuit Switched) call using a 2G/3G communication system, a VoIP (Voice Over Internet Protocol) call using a 4G communication system, or a networked call using a communication software product, but it is not limited thereto. The communication software product may be, for example, Line, What's app, Facetime, or Skype. In step S204, the processor 130 checks whether the mobile terminated call matches the call rule stored in the storage device 110. If the mobile terminated call does not match the call rule, the procedure proceeds to step S250, and the electronic device 100 operates normally (e.g., the user may answer the mobile terminated call normally). If the mobile terminated call matches the call rule, in step S206, the processor 130 notifies the user of the predetermined call approach corresponding to the call rule. For example, a first alert window may pop up on a touch control panel of the electronic device 100 to notify the user of the predetermined call approach. In step S208, the processor 130 checks whether the user accepts the predetermined call approach. For example, the user may accept or reject the predetermined call approach by touching an “OK” button or a “NO” button on the first alert window, and the processor 130 may obtain the user's response by analyzing the aforementioned user input signal. If the user does not accept the predetermined call approach, the procedure proceeds to step S250, and the electronic device 100 operates normally (e.g., the user may answer the mobile terminated call normally). If the user accepts the predetermined call approach, in step S210, the processor 130 rejects the mobile terminated call. Then, in step S214, the processor 130 further performs a callback to the caller according to the predetermined call approach.

In some embodiments, the storage device 110, the transceiver 120, and the processor 130 are respectively implemented with multiple circuits. In some embodiments, the storage device 110, the transceiver 120, and the processor 130 are integrated into a single circuit. In some embodiments, the storage device 110, the transceiver 120, and the processor 130 are implemented with program codes stored in a non-transitory computer-readable medium and are executed by a processor.

In some embodiments, the storage device 110 stores one or more call rules and one or more corresponding predetermined call approaches, and they are described in Table I.

TABLE I
Call Rules and Predetermined Call Approaches

| | | ID of SIM | | |
|---|---|---|---|---|
| | Telephone | Card of | Status of | |
| | Number of | Electronic | Electronic | Predetermined |
| | Caller | device | device | Call Approach |
| Call | 0987-423- | SIM Card 1 | At Office | CS Call using |
| Rule (1) | XXX | | | SIM Card 1 |
| Call | 0918-911- | SIM Card 2 | Not Roaming | CS Call using |
| Rule (2) | XXX | | | SIM Card 2 |
| Call | 0987-913- | Don't Care | Don't Care | VoIP |
| Rule (3) | XXX | | | |
| Call | 0911-XXX- | SIM Card 2 | Don't Care | Networked Call |
| Rule (4) | XXX | | | using |
| | | | | Communication |
| | | | | Software Product |

In the embodiment of Table I, each of the call rules (1) to (4) includes three conditions, such as a telephone number of the caller, identification (ID) of the SIM card of the electronic device 100, and a status of the electronic device 100. More particularly, the identification of the SIM card may be ICCID (Integrated Circuit Card Identifier). The processor 130 may compare information of the mobile terminated call with all of these conditions, and may determine whether the mobile terminated call matches any one of the call rules (1) to (4) accordingly. For example, the processor 130 may determine that the call rule (1) is matched if the telephone number of the caller is “0987-423-XXX”, the mobile terminated call is directed to a first SIM card of the electronic device 100, and the electronic device 100 is positioned at an office. Moreover, for example, the processor 130 may determine that the call rule (2) is matched if the telephone number of the caller is “0918-911-XXX”, the mobile terminated call is directed to a second SIM card of the electronic device 100, and the electronic device 100 is not roaming abroad. It is understood that in Table I, “Don't Care” means that the condition is always satisfied, and “XXX” means specific numbers or any numbers. For example, the processor 130 may determine that the call rule (3) is matched if the telephone number of the caller is “0987-913-XXX”, regardless of the identification of the SIM card and the status of the electronic device 100. According to the matched call rule, the processor 130 may further determine the corresponding predetermined call approach and notify the user (as mentioned above in steps S204 and S206). The corresponding predetermined call approach may indicate a CS call, a VoIP call, or a networked call using a communication software product as the callback, but it is not limited thereto. The communication software product may be, for example, Line, What's app, Facetime, or Skype. The voice data may be transmitted between the user and the caller through a Wi-Fi network or a mobile communication network. For example, if the call rule (4) is matched, the processor 130 may select the corresponding predetermined call approach which indicates a networked call as the callback because the user and the caller may both have Wi-Fi networks. On the other hand, for the electronic device 100 with multiple SIM cards, the corresponding predetermined call approach may further indicate a specific one of the SIM cards. For example, if the call rule (2) is matched, the processor 130 may select the corresponding predetermined call approach which indicates a CS call using the second SIM card as the callback because the second SIM card may have a preferential call service of a free CS call from the user to the caller. Although there are only four call rules and four predetermined call approaches displayed in Table I, it is understood that the above settings are just exemplary, and the storage device 110 may store more, less, or different call rules and corresponding predetermined call approaches in other embodiments. The user may also adjust the above setting according to different requirements.

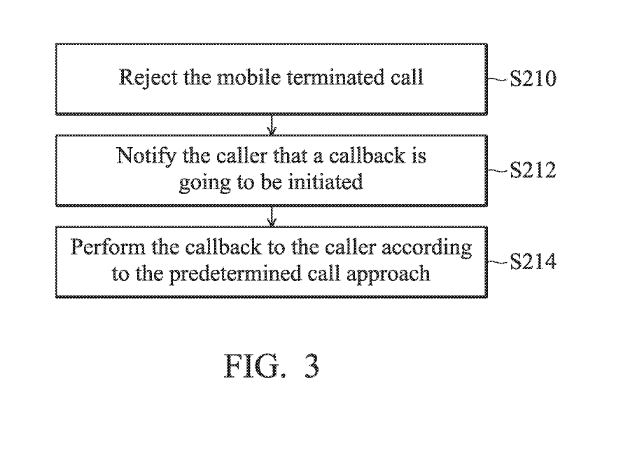

FIG. 3 is a flowchart for illustrating some optional steps of the automatic call control method related to the electronic device 100 according to an embodiment of the invention. Please refer to FIG. 1, FIG. 2, and FIG. 3 together. In the embodiment of FIG. 3, the automatic call control method further includes step S212 arranged after step S210 and before step S214. In step S212, when the mobile terminated call is rejected, the processor 130 notifies the caller that a callback is going to be initiated. The aforementioned notification may be performed by sending a message including specific content, such as “I'll call back soon”. Therefore, the caller will know why the user has rejected the mobile terminated call and will not call again. In other embodiments, the processor 130 can notify the caller in different ways; for example, some specific emoticons or pictures may be sent to the caller, but it is not limited thereto.

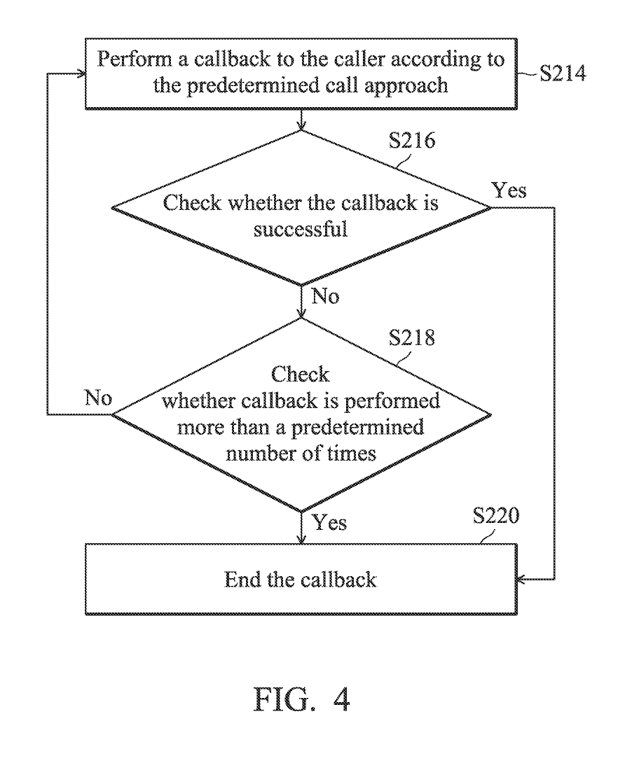

FIG. 4 is a flowchart for illustrating some optional steps of the automatic call control method related to the electronic device 100 according to an embodiment of the invention. Please refer to FIG. 1, FIG. 2, and FIG. 4 together. In the embodiment of FIG. 4, the automatic call control method further includes steps S216 to S220 following step S214. After the callback is performed, in step S216, the processor 130 checks whether the callback is successful. If the callback is not successful, through steps S214 to S218, the processor 130 continuously retries the callback (the procedure may go back to step S214 and be executed several times) until the callback is successful (step S216, Yes) or performed more than a predetermined number of times (step S218, Yes). For example, the predetermined number of times may be 3, 4, or 5. If the callback is successful or performed more than the predetermined number of times (step S216, Yes, or step S218, Yes), the procedure proceeds to step S220, and the processor 130 stops the callback. In such a design, the callback procedure does not become an infinite loop, and therefore it does not affect other normal operations of the electronic device 100.

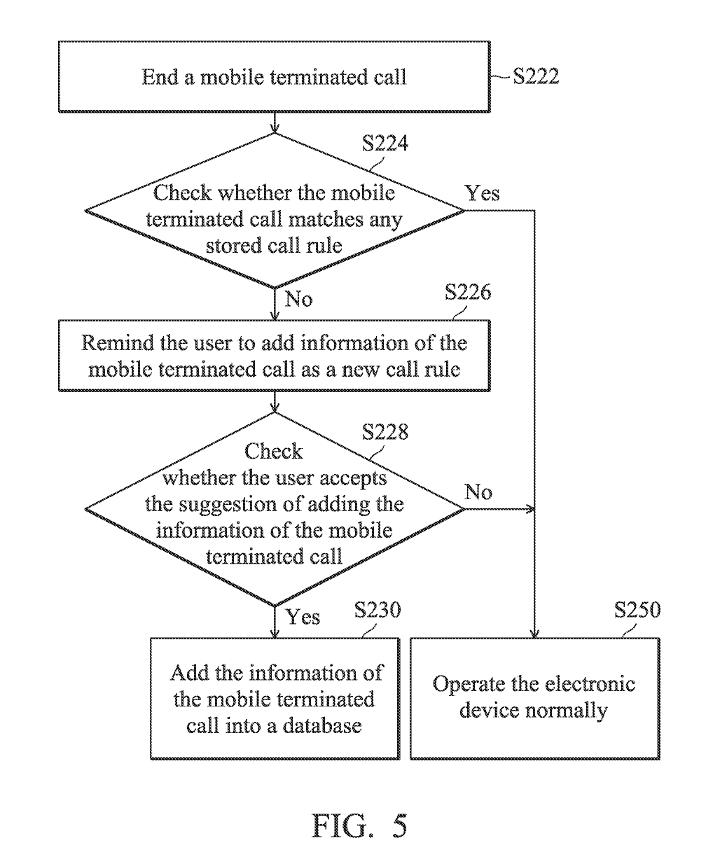

FIG. 5 is a flowchart for illustrating some optional steps of the automatic call control method related to the electronic device 100 according to an embodiment of the invention. Please refer to FIG. 1, FIG. 2, and FIG. 5 together. In the embodiment of FIG. 5, the automatic call control method further includes steps S222 to S230. In step S222, the transceiver 120 receives a mobile terminated call from a caller, and then the mobile terminated call ends (e.g., the user may answer or reject the mobile terminated call, and then it ends). In step S224, the processor 130 checks whether the mobile terminated call matches any call rule stored in the storage device 110. If the mobile terminated call does not match any call rule (i.e., information of the mobile terminated call has not yet been stored in the storage device 110), in step S226, the processor 130 notifies the user to add information of the mobile terminated call into the storage device 110 as a new call rule. For example, a second alert window may pop up on the touch control panel of the electronic device 100 to notify the user. In step S228, the processor 130 checks whether the user accepts the suggestion of adding the information of the mobile terminated call. For example, the user may accept or reject the suggestion by touching an “OK” button or a “NO” button on the second alert window, and the processor 130 may obtain the user's response by analyzing the aforementioned user input signal. In addition, the second alert window may further include a “Don't remind me again” button for the user to permanently stop the reminding procedure. If the user accepts the suggestion, in step S230, the information of the mobile terminated call is added into a database of the storage device 110, and therefore the database of the storage device 110 is updated. The storage device 110 may further display a setting window on the touch control panel of the electronic device 100 for the user to input a new condition of the new call rule and a new predetermined call approach corresponding to the new call rule. In addition, the user can edit the database of the storage device 110 in different ways; for example, the user may use a phonebook application to add some contact information into the storage device 110 as another new call rule. In such a design, the user can easily update and edit the database of the storage device 110, such that the storage device 110 can provide the latest call rules and predetermined call approaches. It is understood that if the mobile terminated call match a call rule or the user does not accept the suggestion of adding the information of the mobile terminated call, the procedure proceeds to step S250, and the electronic device 100 operates normally.

The invention provides a novel automatic call control method for selection of call approaches. By using the automatic call control method, a electronic device can automatically determine the optimized call approach while a mobile terminated call is coming With such a design, inappropriate incoming calls can be rejected, and the best approach of callback can be automatically selected and performed. The invention at least has the advantages of saving call charges and improving user experience, and it is suitably applied to a variety of electronic devices with one or more SIM cards.

The above embodiments are just exemplary, rather than limitations of the invention. It is understood that the automatic call control method and the electronic device of the invention are not limited to the configurations of FIGS. 1-5 and Table I. The invention may merely include any one or more features of any one or more embodiments of FIGS. 1-5 and Table I. In other words, not all of the features shown in the figures and tables should be implemented in the automatic call control method and the electronic device of the invention.

The method of the invention, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine; such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine; such as a computer, the machine becomes an apparatus for practicing the disclosed methods. When implemented on a general-purpose processor, the program code combines with the processor to provide a unique apparatus that operates analogously to application specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An automatic call control method for use in an electronic device, comprising the steps of:
receiving a mobile terminated call;
checking whether the mobile terminated call matches a call rule; and
if the mobile terminated call matches the call rule, rejecting the mobile terminated call, and then performing a callback according to a predetermined call approach corresponding to the call rule.

2. The automatic call control method as claimed in claim 1, further comprising:
notifying the predetermined call approach corresponding to the call rule; and
checking whether the predetermined call approach is accepted.

3. The automatic call control method as claimed in claim 1, wherein the mobile terminated call is a CS (Circuit Switched) call, a VoIP (Voice Over Internet Protocol) call, or a networked call using a communication software product.

4. The automatic call control method as claimed in claim 1, wherein the call rule comprises a telephone number of a caller, identification of a SIM (Subscriber Identity Module) card of the electronic device, and/or a status of the electronic device.

5. The automatic call control method as claimed in claim 4, wherein the identification of the SIM card is ICCID (Integrated Circuit Card Identifier).

6. The automatic call control method as claimed in claim 1, wherein the predetermined call approach indicates a CS (Circuit Switched) call, a VoIP (Voice Over Internet Protocol) call, or a networked call using a communication software product as the callback.

7. The automatic call control method as claimed in claim 1, wherein the electronic device comprises one or more SIM (Subscriber Identity Module) cards, and the predetermined call approach further indicates a specific one of the SIM cards for the callback.

8. The automatic call control method as claimed in claim 1, further comprising:
when the mobile terminated call is rejected, notifying a caller that the callback is going to be initiated.

9. The automatic call control method as claimed in claim 1, further comprising:
checking whether the callback is successful; and
if the callback is not successful, continuously retrying the callback until the callback is successful or performed more than a predetermined number of times.

10. The automatic call control method as claimed in claim 1, further comprising:
if the mobile terminated call does not match the call rule, notifying a user to add information of the mobile terminated call after the mobile terminated call ends.

11. An electronic device, comprising:
a storage device, storing at least one call rule and at least one corresponding predetermined call approach;
a transceiver, receiving a mobile terminated call; and
a processor, checking whether the mobile terminated call matches the call rule, wherein if the mobile terminated call matches the call rule, the processor further call control rejects the mobile terminated call and then performs a callback according to the predetermined call approach.

12. The electronic device as claimed in claim 11, wherein the processor further notifies the predetermined call approach corresponding to the call rule, and checks whether the predetermined call approach is accepted.

13. The electronic device as claimed in claim 11, wherein the mobile terminated call is a CS (Circuit Switched) call, a VoIP (Voice Over Internet Protocol) call, or a networked call using a communication software product.

14. The electronic device as claimed in claim 11, wherein the call rule comprises a telephone number of a caller, identification of a SIM (Subscriber Identity Module) card of the electronic device, and/or a status of the electronic device.

15. The electronic device as claimed in claim 14, wherein the identification of the SIM card is ICCID (Integrated Circuit Card Identifier).

16. The electronic device as claimed in claim 11, wherein the predetermined call approach indicates a CS (Circuit Switched) call, a VoIP (Voice Over Internet Protocol) call, or a networked call using a communication software product as the callback.

17. The electronic device as claimed in claim 11, further comprising:
one or more SIM (Subscriber Identity Module) cards, wherein the predetermined call approach further indicates a specific one of the SIM cards for the callback.

18. The electronic device as claimed in claim 11, wherein when the mobile terminated call is rejected, the processor further call controlnotifies a caller that the callback is going to be initiated.

19. The electronic device as claimed in claim 11, wherein the processor further checks whether the callback is successful, and if the callback is not successful, the processor further call controlcontinuously retries the callback until the callback is successful or performed more than a predetermined number of times.

20. The electronic device as claimed in claim 11, wherein if the mobile terminated call does not match the call rule, the processor further notifies a user to add information of the mobile terminated call into the storage device after the mobile terminated call ends.

21. A non-transitory computer-readable medium storing a computer program product operable to cause an electronic device to perform operations comprising:
receiving a mobile terminated call;
checking whether the mobile terminated call matches a call rule; and
if the mobile terminated call matches the call rule, rejecting the mobile terminated call, and then performing a callback according to a predetermined call approach corresponding to the call rule.
